(19) United States
(12) Patent Application Publication
(10) Pub. No.: US 2009/0290802 A1
(43) Pub. Date: Nov. 26, 2009

(54) CONCURRENT MULTIPLE-INSTANCE LEARNING FOR IMAGE CATEGORIZATION

(75) Inventors: Xian-Sheng Hua, Beijing (CN); Guo-Jun Qi, Hefei (CN); Yong Rui, Sammamish, WA (US); Tao Mei, Beijing (CN); Hong-Jiang Zhang, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/125,057

(22) Filed: May 22, 2008

(51) Int. Cl. G06K 9/62

(52) U.S. Cl. 382/225

(57) ABSTRACT

The concurrent multiple instance learning technique described encodes the inter-dependency between instances (e.g. regions in an image) in order to predict a label for a future instance, and, if desired the label for an image determined from the label of these instances. The technique, in one embodiment, uses a concurrent tensor to model the semantic linkage between instances in a set of images. Based on the concurrent tensor, rank-1 supersymmetric non-negative tensor factorization (SNTF) can be applied to estimate the probability of each instance being relevant to a target category. In one embodiment, the technique formulates the label prediction processes in a regularization framework, which avoids overfitting, and significantly improves a learning machine's generalization capability, similar to that in SVMs. The technique, in one embodiment, uses Reproducing Kernel Hilbert Space (RKHS) to extend predicted labels to the whole feature space based on the generalized representer theorem.

### BACKGROUND

With the proliferation of digital photography, automatic image categorization is becoming increasingly important. Such categorization can be defined as the automatic classification of images into predefined semantic concepts or categories.

Before a learning machine can perform classification, it needs to be trained first, and training samples need to be accurately labeled. The labeling process can be both time consuming and error-prone. Fortunately, multiple instance learning (MIL) allows for coarse labeling at the image level, instead of fine labeling at the pixel/region level, which significantly improves the efficiency of image categorization.

In the MIL framework, there are two levels of training inputs: bags and instances. A bag is composed of multiple instances. A bag (e.g., an image) is labeled positive if at least one of its instances (e.g., a region in the image) falls within the concept being sought, and it is labeled negative if all of its instances are negative. The efficiency of MIL lies in the fact that during training, a label is required only for a bag, not the instances in the bag. In the case of image categorization, a labeled image (e.g., a “beach” scene) is a bag, and the different regions inside the image are the instances. Some of the regions are background and may not relate to “beach”, but other regions, e.g., sand and sea, do relate to “beach”. On close examination, one can see that although sand and/or sea do not appear independently in statistics, they tend to appear simultaneously in an image of a “beach” frequently. Such a co-existence or concurrency can significantly boost the belief that an instance (e.g., the sand, the sea etc.) belongs to a “beach” scene. Therefore, in this “beach” scene, there exists an order-2 concurrent relationship between the sea instance (region) and the sand instance (region). Similarly, in this “beach” scene, there also exist higher-order (order-4) concurrent relationships between instances, e.g., sand, sea, people, and sky.

Existing MIL-based image categorization procedures assume that the instances in a bag are independent and have not explored such concurrent relationships between instances. Although this independence assumption significantly simplifies modeling and computations, it does not take into account the hidden information encoded in the semantic linkage among instances, as described in the above “beach” example.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The concurrent multiple instance learning technique described herein learns image categories or labels. Unlike existing MIL algorithms, in which the individual instances in a bag are assumed to be independent of each other, the technique models the inter-dependency between instances in an image. The concurrent multiple instance learning technique encodes the inter-dependency between instances (e.g. regions in an image) in order to predict a label for a future instance, and, if desired the label for an image determined from the label of these instances. More specifically, in one embodiment, concurrent tensors are used to explicitly model the inter-dependency between instances to better capture an image's inherent semantics. In one embodiment, Rank-1 tensor factorization is applied to obtain the label of each instance. Furthermore, in one embodiment, Reproducing Kernel Hilbert Space (RKHS) is employed to extend instance label prediction to the whole feature space in order to determine the label of an image. Additionally, in one embodiment, a regularizer is introduced, which avoids overfitting and significantly improves a learning machine's generalization capability, similar to that in SVMs.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 provides an overview of one possible environment in which the concurrent multiple instance learning technique described herein can be practiced.

FIG. 2 is a diagram depicting one exemplary architecture in which one embodiment of the concurrent multiple instance learning technique can be employed.

FIG. 3 is a flow diagram depicting an exemplary embodiment of a process employing one embodiment of the concurrent multiple instance learning technique.

FIG. 4 is another exemplary flow diagram depicting another exemplary embodiment of a process employing one embodiment of the concurrent multiple instance learning technique.

FIG. 5 is an example of a hypergraph which can be employed in one embodiment of the concurrent multiple instance learning technique

FIG. 6 is a schematic of an exemplary computing device in which the concurrent multiple instance learning technique can be practiced.

### DETAILED DESCRIPTION

In the following description of the concurrent multiple instance learning technique, reference is made to the accompanying drawings, which form a part thereof, and which is shown by way of illustration examples by which the concurrent multiple instance learning technique described herein may be practiced. It is to be understood that other embodiments may be utilized and structural changes may be made without departing from the scope of the claimed subject matter.

### 1.0 Concurrent Multiple Instance Learning Technique.

The following section provides an overview of the concurrent multiple instance learning technique, a brief description of MIL in general, an exemplary architecture wherein the technique can be practiced, exemplary processes employing the technique and details of various implementations of the technique.

1.1 Overview of the Technique

The concurrent multiple instance learning technique encodes the inter-dependency between instances (e.g. regions in an image) in order to predict a label for a future instance, and, if desired, the label for an image determined from the labels of these instances. The concurrent multiple instance learning technique has at least three major contributions to image and region labeling. First, the technique, in one embodiment, uses a concurrent tensor to model the semantic linkage between instances in a set of images. Based on the concurrent tensor, rank-1 supersymmetric non-negative tensor factorization (SNTF) can be applied to estimate the probability of each instance being relevant to a target category. Second, in one embodiment, the technique formulates label prediction processes in a regularization framework, which avoids overfitting, and significantly improves a learning machine's generalization capability, similar to that in Support Vector Machines (SVMs). Third, the technique, in one embodiment, uses Reproducing Kernel Hilbert Space (RKHS) to extend predicted labels to the whole feature space based on a generalized representer theorem. The technique achieves high classification accuracy on both bags (images) and instances (regions of images), is robust to different data sets, and is computationally efficient.

The concurrent multiple instance learning technique can be used in any type of video or image categorization, such as, for example, would be used in automatically assigning metadata to images. The labels can be used for indexing images for the purposes of image and video management (e.g., grouping). It can also be used to associate advertisements with a user's search strings in order to display relevant advertisements to a person searching for information on a computer network. Many other applications are also possible.

1.2 Multiple Instance Learning Background

This section provides some background information on generic multiple instance learning useful to understanding the concurrent multiple instance learning technique described herein.

1.2.1 Bag Level Multiple Instance Level Classification

Existing MIL based image categorization approaches can be divided into two categories according to their classification levels, bag level or instance level. The bag level research line aims at predicting the bag label and hence does not try to gain insight into instance labels. For example, in some techniques, a standard support vector machine (SVM) can be used to predict a bag label with so-called multiple instance (MI) kernels which are designed for bags. Other bag level techniques have adapted boosting to multiple instance learning and Ensemble-EMDD, which is a multiple instance learning algorithm.

1.2.1 Instance Level Multiple Instance Level Classification

Other research (instance level) first attempts to infer a hidden instance label and then predicts a bag label. For example, the Diverse Density (DD) approach employs a scaling and gradient search algorithm to find prototype points in instance space with a maximal DD value. This DD-based algorithm is computationally expensive and overfitting may occur for the lack of a regularization term in the DD measure. Other instant level techniques adopt MIL into a boosting framework, where a noisy-or is used to combine instance labels into bag labels. Yet other techniques extend the DD framework, seeking P(yᵢ=1|Bᵢ={Bᵢ₁,Bᵢ₂, . . . ,Bᵢₙ}), the conditional probability of the label of the i^{th} bag being positive, given the instances in the bag. They use a Logistic Regression (LR) algorithm to estimate the equivalent probability for an instance, P(yᵢⱼ=1|Bᵢⱼ), and then use a combination function (called softmax) to combine P(yᵢⱼ=1|Bᵢⱼ) in a bag to estimate P(yᵢ=1|Bᵢ):

$$P ( {y}_{i} = 1 \vert {B}_{i} ) = {softmax}_{γ} ( {S}_{i 1} , {S}_{i 2} , … , {S}_{in} ) = \frac{{\sum }_{j}^{ } {S}_{ij} \cdot exp ( γ \cdot {S}_{ij} )}{{\sum }_{j}^{ } exp ( γ \cdot {S}_{ij} )} \qquad ( 1 )$$

where Sᵢⱼ=P(yᵢⱼ=1|Bᵢⱼ). The combining function encodes the multiple instance assumption in this MIL algorithm.

1.3 Exemplary Environment for Employing the Concurrent Multiple Instance Learning Technique.

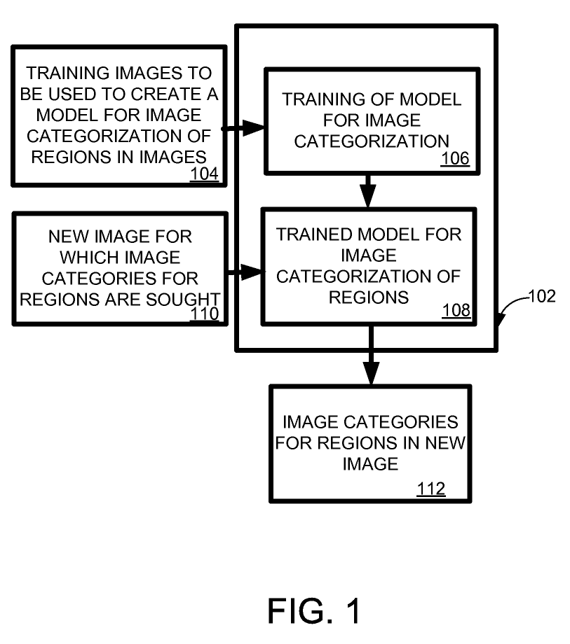

FIG. 1 provides an exemplary environment in which the concurrent multiple instance learning technique can be practiced. This example depicts one generic image categorization environment. Typically training images 104 to be used to create a model for image categorization for regions of images are input into a module 102 that trains 106 a model 108 to be used for image categorization of regions of images, and then allows the use of the trained model 108 for image categorization of regions. Typically, a new image 110 for which image categories for regions are sought is input into the trained model 108. The trained model is then outputs the image categories for the regions in the new image 112.

1.4 Exemplary Architecture Employing the Concurrent Multiple Instance Learning Technique.

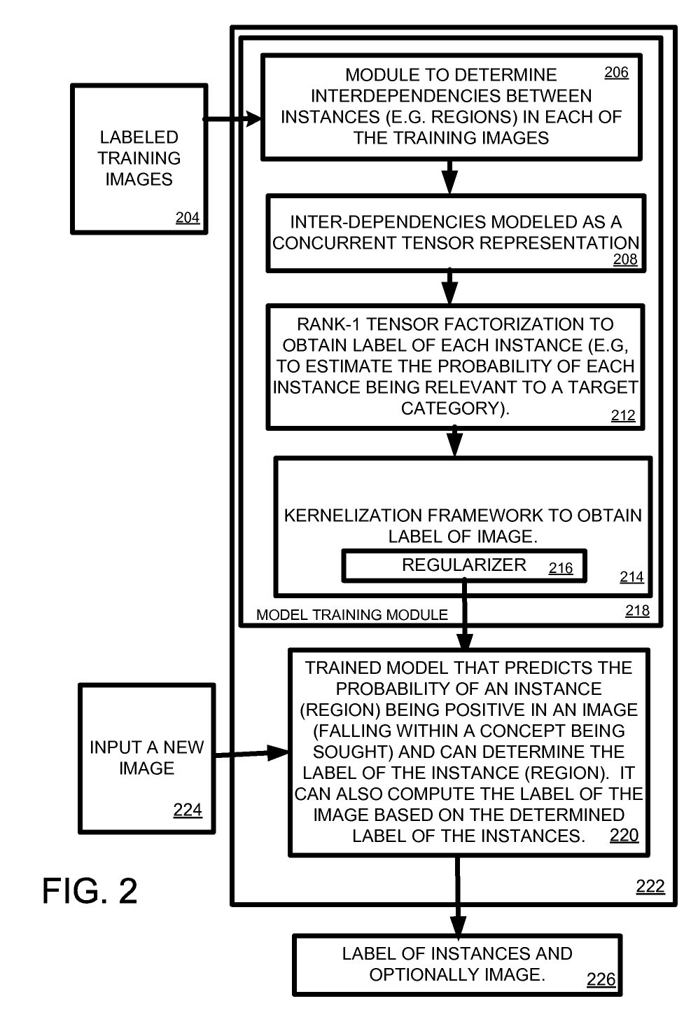

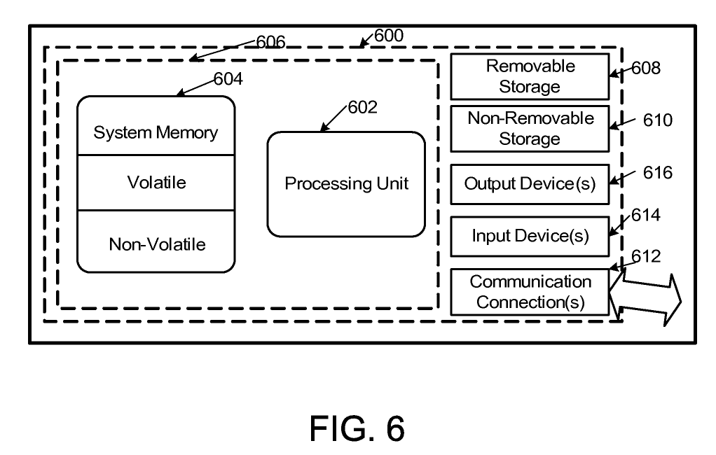

One exemplary architecture that includes a concurrent multiple instance learning module 200 (residing on a computing device 600 such as discussed later with respect to FIG. 6) in which the concurrent multiple instance learning technique can be practiced is shown in FIG. 2. The concurrent multiple instance learning module 200 includes a training module 216 and a trained model 220 which is the output of the training module. In general, labeled training images 204 (where the images themselves are labeled) are input into a module 206 that determines the interdependencies between instances or regions in each of the training images. The instance interdependencies can then be modeled as a concurrent tensor representation in a tensor representation module 208. Rank-1 tensor factorization is then used to obtain the label for each instance in a tensor factorization module 210. More specifically, this module 210 estimates the probability of each instance being relevant to a target category. A kernelization module 214 can then be employed to determine labels for images based on the labels determined for the instances. In one embodiment of the concurrent multiple instance learning technique a regularizer 218 is used to smooth the tensor representation or model of the interdependencies between the instances or regions. The output of this training module 216 is a trained model 220 that predicts the probability of an instance (region) being positive in an image (e.g., falling within a concept being sought) and can determine the label of one or more instances in a new input image 224. The trained model 220 can also compute the label of the new image 224 based on the determined labels of the instances. The output 226 of the concurrent multiple instance learning module 200 in this case is then a label for each of the instances in the new image and optionally a label for the new image itself

1.5 Exemplary Processes Employing the Concurrent Multiple Instance Learning Technique.

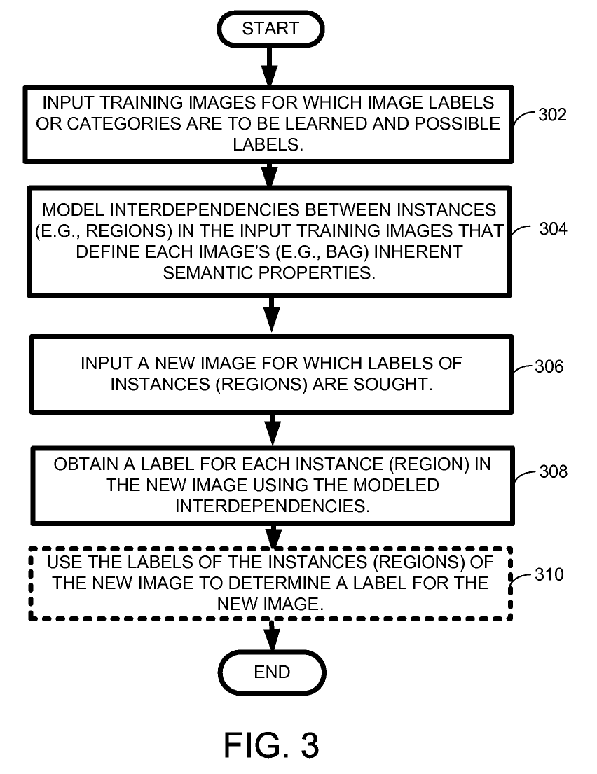

An exemplary process employing the concurrent multiple instance learning technique is shown in FIG. 3. As shown in FIG. 3, (box 302), training images for which image categories or labels are to be learned, and possible labels/categories for these images, are input. Interdependencies between instances or regions of the input training images that define each image's (e.g., bag's) inherent semantic properties are modeled (box 304). A new image for which labels of instances or regions are sought is then input (box 306). A label for each instance (region) in the new image is then obtained using the modeled interdependencies (box 308). Optionally, the obtained labels for each region or instance of the new image can be used to obtain a label for the new image (box 310).

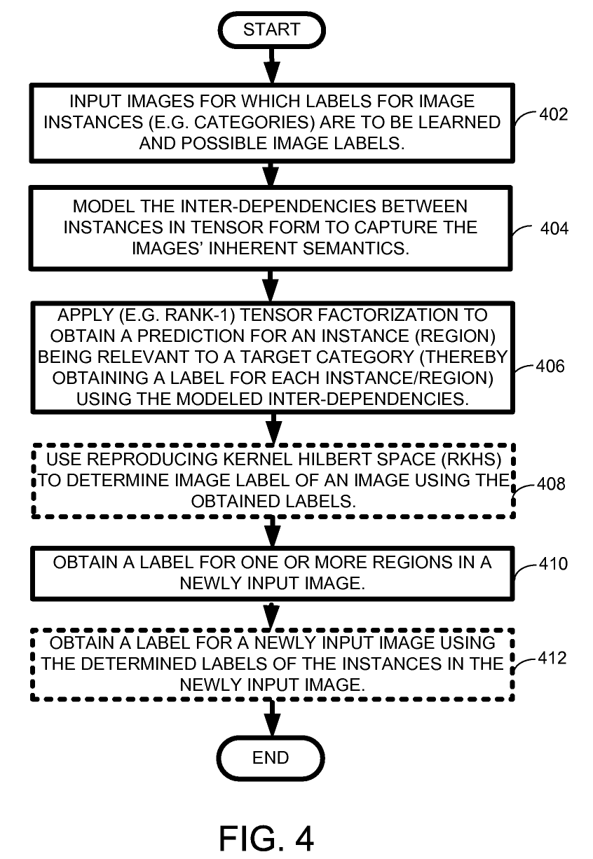

Another exemplary process employing the concurrent multiple instance learning technique is shown in FIG. 4. As shown in FIG. 4, box 402, images for which labels for instances are to be learned, and possible labels/categories for these images, are input. Interdependencies between instances or regions of the input images that define each image's (e.g., bag's) inherent semantic properties are modeled in tensor form (box 404). Tensor factorization (e.g., in one embodiment Rank-1 tensor factorization) is applied to the modeled interdependency in tensor form to obtain labels for instances of the images and to obtain a prediction for an instance being relevant to a target category (box 406). Optionally, in one embodiment, the tensor representation or model of the interdependencies between the instances or regions can be smoothed, as will be discussed later. Reproducing Kernel Hilbert space (RKHS) can then be used to predict an image label of an image using the obtained labels of the regions (box 408). A label for one or more regions in a newly input image can then be obtained using the obtained prediction for an instance being relevant to a target category (box 410). Optionally a label for the newly input image can be obtained using the label for one or more regions in the newly input image (box 412).

It should be noted that many alternative embodiments to the discussed embodiments are possible, and that steps and elements discussed herein may be changed, added, or eliminated, depending on the particular embodiment. These alternative embodiments include alternative steps and alternative elements that may be used, and structural changes that may be made, without departing from the scope of the disclosure.

1.6 Exemplary Embodiments and Details.

Various alternate embodiments of the concurrent multiple instance learning technique can be implemented. The following paragraphs provide details and alternate embodiments of the exemplary architecture and processes presented above. In this section, the details of possible embodiments of the concurrent multiple instance learning technique will be discussed and details of the technique's ability to infer the underlying instance labels will be provided.

1.6.1 Notation

In order to understand the following detailed description of various embodiments of the technique (such as those shown, for example, in FIGS. 2, 3 and 4) notations used in this description will be introduced as follows.

Let Bᵢ denote the i^{th} bag, Bᵢ⁺ a positive bag and Bᵢ⁻ a negative one. One can denote bag set as B={Bᵢ}, positive bag set as B⁻={Bᵢ⁺} and negative bag set as [symbol] ={Bᵢ⁻}. Let I denote the set of instances and n_{I}=| [symbol] the number of all instances. An instance Iⱼ ∈ [symbol] 1≦j≦n is denoted as Iⱼ⁺ when it is positive and is denoted as Iⱼ⁻ when negative. Iⱼ can also be denoted as Bᵢⱼ to emphasize Iⱼ ∈Bᵢ and as Bᵢⱼ⁺ if it is in a positive bag. Here, the subscript j is a global index for instances and does not relate to a specific bag. Let p(Iⱼ) denote the probability of Iⱼ being a positive instance. The symbol p(Iⱼ) is equivalent to P(yᵢⱼ=1|Bᵢⱼ) in equation (1).

1.6.2 Concurrent Hypergraph Representation

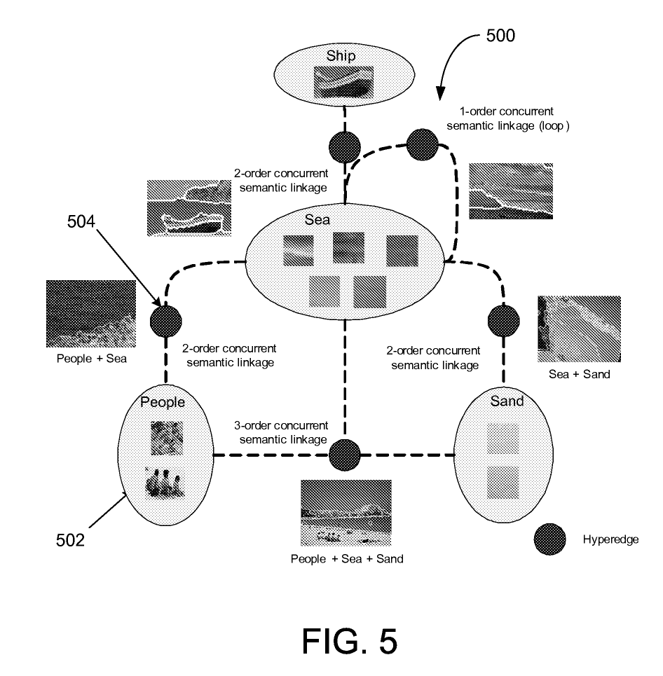

In some embodiments, the concurrent multiple instance learning technique employs hypergraphs in order to determine image region categories. FIG. 5 illustrates an example of concurrent hypergraph G={V, E} 500 for the category “beach” discussed previously, where V 502 and E 504 are the vertex and hyperedge set, respectively. As shown in FIG. 5, the vertices 502 in this hypergraph 500 represent different instances and these instances are linked semantically by hyperedges 504 to encode any order of concurrent relationships between instances in G 500. A statistic quantity is associated with each hyperedge 504 in G 500 to measure these concurrent relationships which will be detailed later. The concurrent relationships, in one embodiment, are based on equation (7)., which will be discussed later.

Based on the concurrent hypergraph G 500, a tensor and its corresponding algebra can naturally be used as a mathematical tool to represent and learn the concurrent relationship between instances. The tensor entries are associated with the hyperedges in G 500. As will detailed in following sections, with the tensor representation, rank-one super-symmetric non-negative tensor factorization (SNTF) can then be applied to obtain p(y_{i,j}=1|Bᵢⱼ), i.e., the probability of an instance Bᵢⱼ being positive. Once the instance label is obtained, the image (e.g., bag) label can be directly computed (for example, by using the combination function shown in Eq. (1)).

1.6.3 Concurrent Relations in MIL

As illustrated in FIG. 5, in images labeled as a specific category (e.g. car, mountain, beach, etc.), there exists some hidden information encoded in the concurrent semantic linkage among different regions (instances) which is useful for instance label inference (as illustrated in FIGS. 2, 3 and 4). This observation prompts one to incorporate these concurrent relations into the process of inferring probability p(Iⱼ). Therefore, one must first determine an appropriate statistic to measure such concurrent relations.

The term p(Iᵢ_{₁} ̂Iᵢ_{₂} ̂ . . . ̂Iᵢ_{ₙ}) is used to denote the probability of the concurrence of n instances Iᵢ_{₁}, Iᵢ_{₂}, . . . , Iᵢ_{ₙ} in the same bag labeled as a certain category, where the notation “̂” means the logic operation “and”. Given the bag set [symbol] ={Bᵢ},the likelihood (bags are assumed to be independent) can be defined as:

p(Iᵢ_{₁} ̂Iᵢ_{₂}̂ . . . ̂Iᵢ_{ₙ}| [symbol] =Πᵢ p(Iᵢ_{₁} ̂Iᵢ_{₂} ̂ . . . ̂Iᵢ_{ₙ}|Bᵢ⁺)·Πᵢ p(Iᵢ_{₁} ̂Iᵢ_{₂} ̂ . . . ̂Iᵢ_{ₙ}|Bᵢ⁻) (2)

Typically, the logic operation “̂” in equation (2) can be estimated by “min”, so one has

p(Iᵢ_{₁} ̂Iᵢ_{₂} ̂ . . . ̂Iᵢ_{ₙ}|Bᵢ)=minₖ{p(Iᵢ_{ₖ}|Bᵢ)} (3)

Adopting a noisy-or model, the probability that not all points missed the target concept is

p(Iᵢ_{ₖ}|Bᵢ⁺)=p(Iᵢ_{ₖ}|Bᵢ₁⁺, Bᵢ₁⁺, . . . )=1−Πⱼ(1−p(Iᵢ_{ₖ}|Bᵢⱼ⁺)) (4)

and likewise

p(Iᵢ_{ₖ}|Bᵢ)=p(Iᵢ_{ₖ}|Bᵢ₁, Bᵢ₁, . . . )=Πⱼ(1−p(Iᵢ_{ₖ}|Bᵢⱼ)) (5)

Concatenating equation (2), (3), (4) and (5) together, one has

$$p ( {I}_{{i}_{1}} ⋀ {I}_{{i}_{2}} ⋀ … ⋀ {I}_{{i}_{n}} \vert = {\prod }_{i}^{ } {min}_{k} \{ 1 - {\prod }_{j}^{ } ( 1 - p ( {I}_{{i}_{k}} \vert {B}_{ij}^{+} ) ) \} \cdot {\prod }_{l} {min}_{k} \{ {\prod }_{j} ( 1 - p ( {I}_{{i}_{k}} \vert {B}_{{l}_{j}}^{-} ) ) \} \qquad ( 6 )$$

The causal probability of an individual instance on a potential target p(Iᵢ_{ₖ}|Bᵢⱼ) can be modeled as related to the distance between them, that is p(Iᵢ_{ₖ}|Bᵢⱼ)=exp(−∥Bᵢⱼ−Iᵢ_{ₖ}∥²). As p(Iᵢ_{₁} ̂Iᵢ_{₂} ̂ . . . ̂Iᵢ_{ₙ}| [symbol] ) is the likelihood over the entire set [symbol] with m=| [symbol] independent bags, and p(Iᵢ_{₁} ̂Iᵢ_{₂} ̂ . . . ̂Iᵢ_{ₙ}) is the concurrent probability in one arbitrary bag, one has p(Iᵢ_{₁} ̂Iᵢ_{₂} ̂ . . . ̂Iᵢ_{ₙ})^{m}=p(Iᵢ_{₁} ̂Iᵢ_{₂} ̂ . . . ̂Iᵢ_{ₙ}| [symbol] ). Then the concurrent probability can be estimated as

$$p ( {I}_{{i}_{1}} ⋀ {I}_{{i}_{2}} ⋀ … ⋀ {I}_{{i}_{n}} ) = \{ {p ( {I}_{{i}_{1}} ⋀ {I}_{{i}_{2}} ⋀ … ⋀ {I}_{{i}_{n}} \vert \}}^{\frac{1}{m}} \qquad ( 7 )$$

Consequently, p(Iᵢ_{₁} ̂Iᵢ_{₂} ̂ . . . ̂Iᵢ_{ₙ}) is regarded as a measure of n-order concurrent relations among Iᵢ_{₁}, Iᵢ_{₂}, . . . , Iᵢ_{ₙ}, which reflects the probability that Iᵢ_{₁}, Iᵢ_{₂}, . . . , Iᵢ_{ₙ} occur at the same time in a positive bag.

1.6.4 Representation of Concurrent Relations as Tensors

There has been considerable interest in learning with higher order relations in many different applications, such as model selection problems, and multi-way clustering. Hypergraphs and their tensors are natural ways to represent concurrent relationships between instances (e.g. the concurrent relationships shown in FIG. 5).

As shown in FIG. 2, box 208, FIG. 3 box 304 and FIG. 4, box 404, in the concurrent multiple instance learning technique, high order tensors can be employed to model any order of concurrent relations among instances, and rank-one super-symmetric non-negative tensor factorization (SNTF) can be applied in some embodiments to obtain P(yᵢⱼ=1|Bᵢⱼ), i.e., the probability of an instance Bᵢⱼ being positive. Different from typical tensor representations, the entries of the tensors in the concurrent multiple instance learning technique are used to represent concurrent relations of the instances, instead of their affinity. Specifics of how the tensor representations are mathematically manipulated in one embodiment of the technique will be described in the following paragraphs.

An n-order tensor τ of dimension [d₁]×[d₂]× . . . [dₙ], indexed by n indices i₁, i₂, . . . , iₙ with 1≦iⱼ≦dⱼ, is of rank-1 if it can be expressed by the generalized outer product of n vectors: τ=vᵢ [symbol] v₂ . . . [symbol] vₙ, where vᵢ ∈ [symbol] . A tensor τ is called super-symmetric when its entries are invariant under any permutation of their indices. For such a supersymmetric tensor, its factorization has a symmetric form: τ=v [symbol] ⁿ=vᵢ [symbol] v₂ . . . [symbol] vₙ. A direct gradient descent based approach was adopted in the present technique to factor tensors, as will be discussed in greater detail below.

Once the concurrent relations are represented in an n-order tensor form (e.g., as shown in FIG. 4, box 404), in one embodiment, a rank-1 tensor factorization procedure is then utilized to derive p(Iⱼ), i.e., the probability of Iⱼ being a positive instance. The following explanation correlates to boxes 404 and 406 of FIG. 4, and provides a more detailed explanation of one way of implementing these portions of the technique. The concurrent relations measured by p(Iᵢ_{₁} ̂Iᵢ_{₂} ̂ . . . ̂Iᵢ_{ₙ}) are the entries of a high order tensor in the technique's framework. This tensor is named the concurrent tensor. The variable T is used to denote this tensor. From equations (6) and (7), the entry of this tensor is given by

$${T}_{{i}_{1} , {i}_{2} , … {,}_{{i}_{n}}} {=}^{Δ} p ( {I}_{{i}_{1}} ⋀ {I}_{{i}_{2}} ⋀ … ⋀ {I}_{{i}_{n}} ) = {\{ \begin{matrix}{\prod }_{i} {min}_{k} \{ 1 - {\prod }_{j} ( 1 - p ( {I}_{{i}_{k}} \vert {B}_{ij}^{+} ) ) \} \cdot \\ {\prod }_{l} {min}_{k} \{ {\prod }_{j} ( 1 - p ( {I}_{{i}_{k}} \vert {B}_{lj}^{-} ) ) \}\end{matrix} \}}^{\frac{1}{m}} , 1 \leq {i}_{1} , {i}_{2} , … , {i}_{n} \leq {n}_{I} \qquad ( 8 )$$

Since the bag label and the concurrent relation information have been incorporated into T, this concurrent tensor is a supervised measure instead of an unsupervised affinity measure.

Given the concurrent tensor T, the technique seeks to estimate p(Iⱼ), i.e., the probability of instance Iⱼ being a positive instance. The desired probabilities form a nonnegative 1×nⱼ of vector P=[p(I₁), p(I₂), . . . p(Iₙ_{_{I}})]^{T}, thus the goal is to find P given tensor T. As p(Iᵢ_{₁} ̂Iᵢ_{₂} ̂ . . . ̂Iᵢ_{ₙ}) is equivalent to min{P(Iᵢ_{₁}), p(Iᵢ_{₂}), . . . , p(Iᵢ_{ₙ})} according to logic operation “̂”. Equation (8) is then converted into a set of n_{I}ⁿ equations with 1≦i₁,i₂, . . . ,iₙ≦n_{I}:

$${T}_{{i}_{1} , {i}_{2} , … , {i}_{n}} {=}^{Δ} p ( {I}_{{i}_{1}} ⋀ {I}_{{i}_{2}} ⋀ … ⋀ {I}_{{i}_{n}} ) = min \{ p ( {I}_{{i}_{1}} ) , p ( {I}_{{i}_{2}} ) , … , p ( {I}_{{i}_{n}} ) \}$$

It is an over-determined problem to solve no unknown variables p(Iⱼ),1≦j≦n_{I}, and it is computationally expensive to find an optimal solution to the probability vector P if it is exhaustively searched for in the n_{I} dimension space Rⁿ^{_{I}}.

Alternatively, in one embodiment, the technique relaxes the non-differentiable operation “min” to a differentiable function, and then a gradient search algorithm is adopted to efficiently search for the optimal solution to P. The logic “̂” can also been estimated by a kind of T-norm function. More specifically, the multiplication operation has been proven to be such an operator, and the “min” operator is an upper bound of the “multiplication” operator:

p(Iᵢ_{₁})·p(Iᵢ_{₂}) . . . p(Iᵢ_{ₙ})≦min{p(Iᵢ_{₁}), p(Iᵢ_{₂}), . . . , p(Iᵢ_{ₙ})} (10)

Therefore an alternative solution is to use “multiplication” to estimate the logic “̂”:

Tᵢ_{₁}_{,i}_{₂}_{, . . . ,i}_{ₙ}=p(Iᵢ_{₁}̂Iᵢ_{₂} ̂ . . . ̂Iᵢ_{ₙ})≐p(Iᵢ_{₁})≈p(Iᵢ_{₂}) . . . p(Iᵢ_{ₙ}) (11)

In this form, the set of n_{I}ⁿ equations can be represented in a compact tensor form:

$$\underbrace{T = P ⊗ P ⊗ … ⊗ P}_{n terms} = {P}^{⊗ n} \qquad ( 12 )$$

The above equation can be translated to the fact that T is a rank-1 super-symmetric tensor, and P can be calculated given the concurrent tensor T. Equation (12) is an over-determined multi-linear system with nᵢⁿ equations like (11). This problem can be solved by searching for an optimal solution P to approximate the tensor T in light of least-squared criterion, and the obtained P can best reflect the semantic linkage among instances represented by T.

In order to find the best solution to P, one considers the following least-squared problem:

$${min}_{P} C ( P ) = \frac{1}{2} {‖ T - {P}^{⊗ n} ‖}_{F}^{2} \\ s . t . P \geq 0 \qquad ( 13 )$$

where ∥·∥_{F}² the squared Frobenious norm defined as ∥K∥_{F}²= [symbol] K,K [symbol] =Σᵢ_{₁}_{,i}_{₂}_{, . . . i}_{ₙ}. The entries in a super-symmetric tensor do not depend on the order of the indices, one can only store a single representative for each n-tuple and focus on the entries where i₁≦i₂≦ . . . ≦iₙ. This saves a great deal of memory to store the tensor T.

The most direct approach is to form a gradient descent scheme. To that end, the gradient function with respect to P is derived first. Following that the differential commutes with inner-product operation [symbol] ·,· [symbol] , i.e., d [symbol] K,K [symbol] =2 [symbol] K,dK [symbol] and the identity d(P [symbol] ⁿ)=(dP) [symbol] P [symbol] ⁽ⁿ⁻¹⁾+ . . . +P [symbol] ⁽ⁿ⁻¹⁾ [symbol] (dP), one has

$$\begin{matrix}d C ( P ) = d \frac{1}{2} 〈 T - {P}^{⊗ n} , T - {P}^{⊗ n} 〉 \\ = 〈 T - {P}^{⊗ n} , d [ T - {P}^{⊗ n} ] 〉 \\ = 〈 {P}^{⊗ n} - T , d ( {P}^{⊗ n} ) 〉 \\ = 〈 {P}^{⊗ n} - T , ( d P ) ⊗ {P}^{⊗ ( n - 1 )} + … + {P}^{⊗ ( n - 1 )} ⊗ ( d P ) 〉\end{matrix} \qquad ( 14 )$$

Then the partial derivative with respect to pⱼ (the j^{th} entry of P) is:

$$\begin{matrix}\frac{\partial C ( P )}{\partial {p}_{j}} = 〈 {P}^{⊗ n} - T , {e}_{j} ⊗ {P}^{⊗ ( n - 1 )} + … + {P}^{⊗ ( n - 1 )} ⊗ {e}_{j} 〉 \\ = 〈 {P}^{⊗ n} , {e}_{j} ⊗ {P}^{⊗ ( n - 1 )} + … + {P}^{⊗ ( n - 1 )} ⊗ {e}_{j} 〉 - \\ 〈 T , {e}_{j} ⊗ {P}^{⊗ ( n - 1 )} + … + {P}^{⊗ ( n - 1 )} ⊗ {e}_{j} 〉 \\ = n \cdot {p}_{j} \cdot {‖ p ‖}^{n - 1} - {\sum }_{r = 1}^{n} {\sum }_{S / {i}_{r}} {T}_{{S}_{{i}_{r} ← j}} {\prod }_{m \neq r} {p}_{{i}_{m}}\end{matrix} \qquad ( 15 )$$

where eⱼ is the standard vector (0, 0, . . . , 1, 0, . . . , 0) with 1 in the j^{th} coordinate, and S represents an n-tuple index, s/iᵣ denotes {i₁, . . . , iᵣ₋₁, iᵣ₊₁, . . . , iₙ}, Sᵢ_{ᵣ}ⱼ the set of indices S where the index iᵣ is replaced by j. Hence, the gradient function with respect to P is obtained, that is,

$${∇}_{P} C ( P ) = {[ \frac{\partial C ( P )}{\partial {p}_{1}} \frac{\partial C ( P )}{\partial {p}_{2}} … \frac{\partial C ( P )}{\partial {p}_{{n}_{I}}} ]}^{T} \qquad ( 16 )$$

With this gradient, a direct gradient descent scheme can be applied to form an iterative algorithm of search for the best solution P. However, this solution to P is limited to the available set of instances and does not naturally extend to the case where novel examples need to classified. In the following section, an approach to extend the solution P to the whole feature space in a natural way, i.e. find an optimal function p(x) defined on the whole feature space to give the probability of an instance of being positive, is given. In the following section, an optimization-based approach to find the optimal solution to p(x) in Reproducing Kernel Hilbert Space (RKHS) is employed.

1.6.5 A Kernelization Framework

The description in this section relates to boxes 214 and 216 of FIG. 2 and box 408 of FIG. 4. In this section, two concepts will be discussed. First, the estimated posterior probability vector P is extended to a function over the whole feature space by a kernelized representation of the objective problem (13), which is based on the generalized representer theorem. >>can you add some details on what a generalized representer theorem is or does?>>>Second, in this kenelization form, a regularization term is adopted to generate a regularized function p(x) over feature space, which is able to avoid an overfitting problem in the noisy-or likelihood model.

To begin, the objective cost function in problem (13) is rewritten. Given function p(x), the probability vector P in (13) can be given as P=[p(I₁), p(I₂), . . . p(Iₙ_{_{I}})]^{T} where {Iᵢ}ᵢ₋₁ⁿ^{_{I}} are the instances in the training set.

Therefore, the cost function in (13) can be rewritten as

$$C ( p ( x ) , {\{ {I}_{i} \}}_{i = 1}^{{n}_{I}} ) = \frac{1}{2} {‖ T - {P}^{⊗ n} ‖}_{F}^{2} .$$

Note that different from (13), C(p(x), {Iᵢ}ᵢ₌₁ⁿ^{_{I}}) is defined as a function of p(x) instead of vector P, and this cost function will be minimized with respect to the function p(x). Secondly, a multiplicative noisy-or model is used in a multiple-instance setting, which is often sensitive to instances in negative bags. Furthermore, when the concurrent tensor order increases, a more complex underlying hypergraph as shown in FIG. 5 is utilized to model the semantic relations among instances, and consequently, such a complicated model tends to overfit the concurrent likelihood in equation (6), therefore, to avoid such overfitting in the inference of p(x), a regularization term Ω(∥p(x)∥ [symbol] ) is needed to control the complexity of such high-order tensor model by penalizing the RKHS norm to impose a smoothness condition on possible solutions. Here [symbol] denotes RKHS, ∥·∥ [symbol] the norm in this Hilbert space, and Ω(·) is a strictly monotonically increasing function. Combining the above two considerations, the final optimization problem can be written as

$$\begin{matrix}{min}_{p ( x ) ∈ ℋ} F ( p ( x ) , {\{ {I}_{i} \}}_{i = 1}^{{n}_{I}} ) = C ( p ( x ) , {\{ {I}_{i} \}}_{i = 1}^{{n}_{I}} ) + λ \cdot Ω ( {‖ p ( x ) ‖}_{ℋ} ) \\ = \frac{1}{2} {‖ T - {P}^{⊗ n} ‖}_{f}^{2} + λ \cdot Ω ( {‖ p ( x ) ‖}_{ℋ} ) \\ where P = {[ p ( {I}_{1} ) , p ( {I}_{2} ) , … p ( {I}_{{n}_{I}} ) ]}^{T} s . t . p ( x ) \geq 0\end{matrix} \qquad ( 17 )$$

where λ is a parameter that trades off the two components.

Since the above objective function F(p(x), {Iᵢ}ᵢ₌₁ⁿ^{_{I}}) is pointwise, which means it only depends on the value of p(x) at the data points {Iᵢ}ᵢ₌₁ⁿ^{_{I}}, according to the generalized representer theorem, the minimizer p*(x) exists in RKHS and admits a representation of the form

$${p}^{*} ( \cdot ) = {\sum }_{i = 1}^{{n}_{I}} {α}_{i} k ( \cdot , {I}_{i} ) . \qquad ( 18 )$$

where k(·,·) is a Mercer Kernel associated with RKHS

[symbol]

Let K=[k(Iᵢ, Iⱼ)]ₙ_{_{I}}_{×n}_{_{I}} denote n_{I}×n_{I} Gram matrix with the kernel function

$$k ( {I}_{i} , {I}_{j} ) = exp ( - \frac{{‖ {I}_{i} - {I}_{j} ‖}^{2}}{2 {σ}^{2}} )$$

(Gaussian Kernel) over instance features and coefficient vector, a=[a₁ a₂ . . . aₙ_{_{I}}]^{T} in equation (20). Using

$$Ω ( {‖ p ( x ) ‖}_{ℋ} ) = \frac{1}{2} {‖ p ( x ) ‖}_{ℋ}^{2}$$

and substitute (18) into (17), the following optimization problem is obtained:

$${min}_{α} F ( α ) = \frac{1}{2} {‖ T - {( K \cdot α )}^{⊗ n} ‖}_{F}^{2} + \frac{1}{2} {λα}^{T} K α \\ s . t . α \geq 0 \qquad ( 19 )$$

To solve it, the gradient of F(a) is derived with respect to a:

$$\begin{matrix}{∇}_{α} F ( α ) = {∇}_{α} C ( p ( x ) , {\{ {I}_{i} \}}_{i = 1}^{{n}_{I}} ) + \frac{1}{2} λ \cdot {∇}_{α} ( {α}^{T} K α ) \\ = K \cdot {∇}_{P} C ( P ) + λ K \cdot α\end{matrix} \qquad ( 20 )$$

Where ∇_{P}C is the gradient of cost function C(p(x), {Iᵢ}ᵢ₌₁ⁿ^{_{I}}) with respect to vector P derived in equations (15) and (16).

With this obtained gradient, a L-BFGS quasi-Newton method can used to solve this optimization problem. This method is a standard optimization algorithm which can be used to solve the optimal p(x) in equation (17). It searches for the whole space allowed by the constraints of equation (17) in the gradient direction of equation (20). By building up an approximation scheme through successive evaluation of the gradient in equation (20), L-BFGS can avoid the explicit estimation of a Hessian matrix. It has been proven L-BFGS has a fast convergence rate to learn the parameters a than traditional scaling learning algorithms. It should be noted, however, that other methods can be used to solve this optimization problem also.

### 2.0 The Computing Environment

The concurrent multiple instance learning technique is designed to operate in a computing environment. The following description is intended to provide a brief, general description of a suitable computing environment in which the concurrent multiple instance learning technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

FIG. 6 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 6, an exemplary system for implementing the concurrent multiple instance learning technique includes a computing device, such as computing device 600. In its most basic configuration, computing device 600 typically includes at least one processing unit 602 and memory 604. Depending on the exact configuration and type of computing device, memory 604 may be volatile (such as RAM), non-volatile (such as ROM, flash memory, etc.) or some combination of the two. This most basic configuration is illustrated in FIG. 6 by dashed line 606. Additionally, device 600 may also have additional features/functionality. For example, device 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer readable instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 600. Any such computer storage media may be part of device 600.

Device 600 may also contain communications connection(s) 612 that allow the device to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 600 may have various input device(s) 614 such as a display, a keyboard, mouse, pen, camera, touch input device, and so on. Output device(s) 616 such as speakers, a printer, and so on may also be included. All of these devices are well known in the art and need not be discussed at length here.

The concurrent multiple instance learning technique may be described in the general context of computer-executable instructions, such as program modules, being executed by a computing device. Generally, program modules include routines, programs, objects, components, data structures, and so on, that perform particular tasks or implement particular abstract data types. The concurrent multiple instance learning technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented process for labeling regions in images, comprising:
inputting training images for which image labels are to be learned, and a set of possible image labels;
modeling interdependencies between regions of the input training images that define each image's inherent semantic properties;
inputting a new image for which labels of regions are sought; and
obtaining a label for each region in the new image using the modeled interdependencies.

2. The computer-implemented process of claim 1 further comprising:
obtaining a label for the new image using the labels for the regions obtained in the new image.

3. The computer-implemented process of claim 1, further comprising modeling the interdependencies between regions of the input training images as a concurrent tensor representation.

4. The computer-implemented process of claim 3 further comprising using tensor factorization to obtain a label for each region in the training images.

5. The computer-implemented process of claim 4, further comprising using tensor factorization to estimate the probability of each region in any image being relevant to a target label category.

6. The computer-implemented process of claim 5, further comprising determining the label of each region of a new image using the estimated probability.

7. The computer-implemented process of claim 4 further comprising using rank-1 tensor factorization to obtain a label for each region in the training images

8. The computer-implemented process of claim 1 further comprising using a kernelization framework to obtain the label of the new image.

9. The computer-implemented process of claim 1 further comprising using a regularizer to smooth the modeled interdependencies between the instances or regions.

10. A computer-implemented process for labeling instances in an image, comprising:
inputting images for which labels for image instances are to be learned, and a set of possible image labels;
modeling interdependencies between instances of the input images that define each image's inherent semantic properties in tensor form;
applying tensor factorization to the modeled interdependencies to obtain a prediction for an instance being relevant to a target category; and
using the prediction for an instance being relevant to a target category to obtain one or more labels for instances of a newly input image.

11. The computer-implemented process of claim 10 further comprising determining an image label for the newly input image.

12. The computer-implemented process of claim 10 further comprising using Reproducing Kernel Hilbert space (RKHS) to determine an image label of the newly input image using the obtained instance labels.

13. The computer-implemented process of claim 10 wherein applying tensor factorization to the modeled inter-dependency in tensor form further comprises applying Rank-1 tensor factorization.

14. The computer-implemented process of claim 10 further comprising using a hyper-graph to model concurrent interdependencies between instances.

15. The computer-implemented process of claim 14 wherein the vertices in the hyper-graph represent different instances and these instances are linked semantically by hyper-edges to encode any order of concurrent interdependencies between instances in the hyper-graph.

16. A system for categorizing regions of an image, comprising:
a general purpose computing device;
a computer program comprising program modules executable by the general purpose computing device, wherein the computing device is directed by the program modules of the computer program to,
input labeled training images wherein the images themselves are labeled;
train a model to predict image region labels based on interdependencies between regions in each of the training images;
label regions in a new image using the trained model.

17. The system of claim 16 further comprising a module to obtain a label for the new image based on labels of the regions in the new image.

18. The system of claim 16 wherein the interdependencies between regions are modeled as a concurrent tensor representation.

19. The system of claim 18 further comprising estimating the probability of each region being relevant to a target category using the interdependencies between regions modeled as a concurrent tensor representation.

20. The system of claim 16 further comprising a kernelization module that determines labels for images based on the labels determined for the regions.
